(19) United States
(12) Patent Application Publication
(10) Pub. No.: US 2026/0291282 A1
(43) Pub. Date: Sep. 24, 2026

(54) SEMICONDUCTOR DEVICE AND BATTERYLESS MULTI-TURN ENCODER

(71) Applicant: MITSUBISHI ELECTRIC CORPORATION, Tokyo (JP)

(72) Inventors: Osamu NISHIKIDO, Chiyoda-ku, Tokyo (JP); Akio KAMIMURAI, Chiyoda-ku, Tokyo (JP); Takatsugu SAWAI, Chiyoda-ku, Tokyo (JP); Kazuo NOMURA, Chiyoda-ku, Tokyo (JP)

(73) Assignee: MITSUBISHI ELECTRIC CORPORATION, Tokyo (JP)

(21) Appl. No.: 19/473,173

(22) PCT Filed: Apr. 14, 2023
(86) PCT No.: PCT/JP2023/015201

§ 371 Date: Oct. 7, 2025

(51) Int. Cl. H02J 50/00; H02J 50/10

(52) U.S. Cl. CPC H02J 50/001; H02J 50/10

(57) ABSTRACT

A semiconductor device that operates with a current pulse generated by a power generation element is provided. The semiconductor device includes a processing circuit to perform a series of processes with the current pulse and a determination circuit to determine whether or not an amount of power generation by the power generation element is sufficient. The determination circuit determines whether or not a first determination condition is satisfied before start of the series of processes and during generation of the current pulse by the power generation element and determines whether or not a second determination condition is satisfied while the series of processes is being performed. The processing circuit starts the series of processes when the first determination condition is satisfied and suspends the series of processes when the second determination condition is not satisfied.

### TECHNICAL FIELD

The present disclosure relates to a semiconductor device and further to a batteryless multi-turn encoder.

### BACKGROUND ART

A large number of semiconductor devices have been developed that operate by using as power supply, electric power generated by an energy harvesting element to convert energy obtained from an ambient environment into electric power. The energy harvesting element encompasses a power generation element configured to convert an induced current generated in a coil with change of magnetic field into electric power. A batteryless multi-turn encoder is an exemplary device including such a power generation element utilizing change of magnetic field, and it distinguishes a direction of rotation and the number of rotations of a motor without an external power supply.

Japanese Patent No. 5769879 (PTL 1) discloses a batteryless multi-turn encoder device including a power generation element with a large Barkhausen effect. The large Barkhausen effect refers to a phenomenon of abrupt change of magnetization in certain magnetic field when external magnetic field changes.

Specifically, the batteryless multi-turn encoder described in this literature includes a rotational detection mechanism and a signal processing circuit. The rotational detection mechanism includes a magnet configured to rotate together with a rotational shaft and have N magnetic poles in a circumferential direction of the rotational shaft and L (L being not smaller than two) detection coils configured to have a magnetic wire with the Barkhausen effect with respect to a magnetic field from the magnet and be placed such that their phase angles are deviated from each other on a rotational circumference of the magnet. Each of the detection coils generates voltage pulses with different positive and negative signs and transmits them to the signal processing circuit. The signal processing circuit includes a controller configured to store states of the respective detection coils in a memory and an adder to update the number of rotations according to change in states of each of the detection coils. The signal processing circuit performs a series of operations only with electric power generated from voltage pulses from the detection coils, through full-wave rectifier circuits and a constant-voltage circuit, and completes the operations before generation of the next voltage pulse.

### CITATION LIST

### Patent Literature

PTL 1: Japanese Patent No. 5769879

### SUMMARY OF INVENTION

### Technical Problem

A conventional semiconductor device utilizing the energy harvesting element represented by the batteryless multi-turn encoder described in Japanese Patent No. 5769879 (PTL 1) completes the series of operations for each current pulse generated by the power generation element. Therefore, the signal processing circuit starts the process after all charges necessary for the series of operations are stored in a capacitive element for storage of charges generated by the power generation element. This is because, if electric power runs short in the middle of the series of processes, the processes may not correctly be performed and data may become abnormal.

Stand-by until storage of all charges necessary for the series of processes in the capacitive element, however, is nothing less than application of a high voltage to the coil in the power generation element. A property of the coil is such that, when a voltage is applied to the coil, the coil tends to allow a current to flow in a direction to cancel the voltage. This current in a reverse direction interferes with a generated current. Therefore, as a generated voltage is higher, an amount of charges canceled by the current in the reverse direction disadvantageously increases. If a capacity of the capacitive element is increased in order to suppress the generated voltage, on the other hand, charges until a voltage necessary for driving the signal processing circuit is reached increase, and another problem of increase in unusable charges arises.

The present disclosure was made in consideration of the problems above, and one object thereof is to provide a semiconductor device to efficiently use current pulses generated by a power generation element.

### Solution to Problem

In one embodiment, a semiconductor device that operates with a current pulse generated by a power generation element is provided. This semiconductor device includes a processing circuit to perform a series of processes with the current pulse and a determination circuit to determine whether an amount of power generation by the power generation element is sufficient. The determination circuit determines whether a first determination condition is satisfied before start of the series of processes and during generation of the current pulse by the power generation element and determines whether a second determination condition is satisfied while the series of processes is being performed. The processing circuit starts the series of processes when the first determination condition is satisfied and suspends the series of processes when the second determination condition is not satisfied.

### Advantageous Effects of Invention

According to the embodiment, since the series of processes is started when the amount of power generation is determined as being sufficient during generation of the current pulse by the power generation element and the series of processes is suspended when the amount of power generation is determined as being insufficient while the series of processes is being performed, current pulses generated by the power generation element can efficiently be used.

### BRIEF DESCRIPTION OF DRAWINGS

FIG. 1 is a circuit block diagram of a batteryless multi-turn encoder according to a first embodiment.

FIG. 2 is a timing chart showing an exemplary ordinary process in the batteryless multi-turn encoder in FIG. 1.

FIG. 3 is a timing chart showing an exemplary suspension process in the batteryless multi-turn encoder in FIG. 1.

FIG. 4 is a diagram conceptually showing an amount of charges accumulated in a capacitive element at the time of start and end of each of read, update, and write processes.

FIG. 5 is a diagram conceptually showing change over time in voltage of the capacitive element.

FIG. 6 is a circuit diagram showing an exemplary configuration of a reference voltage generation circuit and a voltage determination circuit in FIG. 1.

FIG. 7 is a circuit diagram showing an exemplary configuration of a charge amount determination circuit in FIG. 1.

FIG. 8 is a circuit diagram showing an exemplary configuration of a selection circuit in FIG. 1.

FIG. 9 is a circuit diagram showing an exemplary configuration of a constant voltage circuit in FIG. 1.

FIG. 10 is a circuit diagram showing an exemplary configuration of a POR circuit in FIG. 1.

FIG. 11 is a circuit block diagram of a batteryless multi-turn encoder according to a second embodiment.

FIG. 12 is a timing chart showing an exemplary ordinary process in the batteryless multi-turn encoder in FIG. 11.

FIG. 13 is a timing chart showing an exemplary suspension process in the batteryless multi-turn encoder in FIG. 11.

FIG. 14 is a diagram for illustrating an exemplary mechanism to detect a write error.

FIG. 15 is a circuit diagram showing an exemplary configuration of a peak determination circuit in FIG. 11.

FIG. 16 is a circuit diagram showing another exemplary configuration of the peak determination circuit in FIG. 11.

FIG. 17 is a circuit block diagram of a batteryless multi-turn encoder according to a third embodiment.

FIG. 18 is a timing chart showing an exemplary ordinary process in the batteryless multi-turn encoder in FIG. 17.

FIG. 19 is a circuit block diagram of a batteryless multi-turn encoder according to a fourth embodiment.

FIG. 20 is a timing chart showing an exemplary ordinary process in the batteryless multi-turn encoder in FIG. 19.

FIG. 21 is a circuit diagram showing an exemplary configuration of a variable voltage generator in FIG. 19.

FIG. 22 is a diagram for illustrating an exemplary method of supplying a voltage to a power supply terminal of a voltage buffer in FIG. 21.

FIG. 23 is a circuit block diagram of a batteryless multi-turn encoder according to a fifth embodiment.

FIG. 24 is a timing chart showing an exemplary ordinary process in the batteryless multi-turn encoder in FIG. 23.

### DESCRIPTION OF EMBODIMENTS

Each embodiment will be described in detail below with reference to the drawings. Though a batteryless multi-turn encoder will be described by way of example in an embodiment below, a technique in the present disclosure is not limited thereto. For example, the technique in the present disclosure is applicable to various semiconductor devices that operate with current pulses from a power generation element to generate electric power through electromagnetic induction. In the description below, the same or corresponding elements have the same reference characters allotted and description thereof may not be repeated.

### First Embodiment

### [Configuration of Batteryless Multi-Turn Encoder]

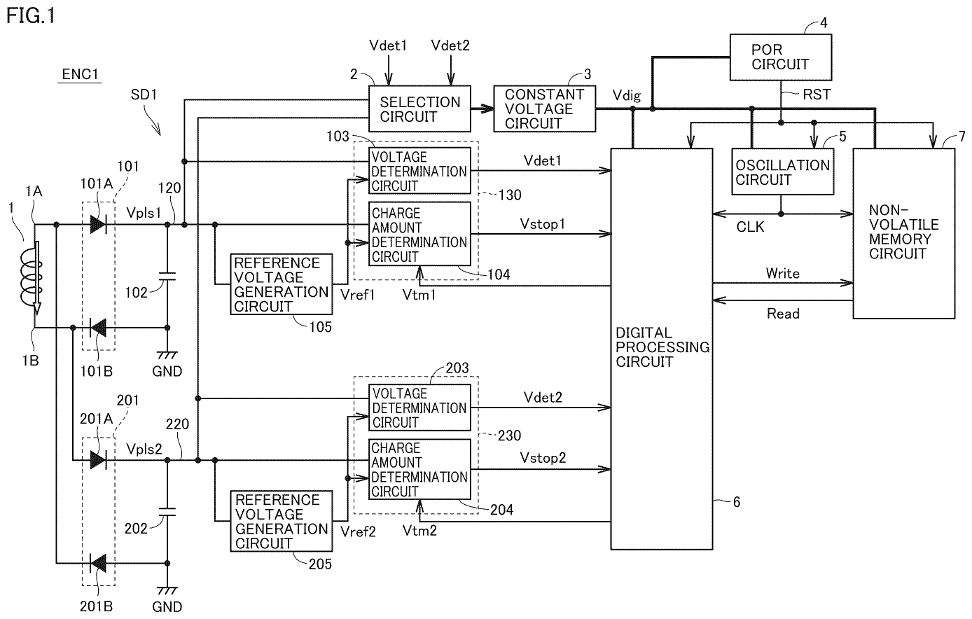

FIG. 1 is a circuit block diagram of a batteryless multi-turn encoder ENC1 according to a first embodiment. Batteryless multi-turn encoder ENC1 in FIG. 1 includes a power generation element 1 to generate electric power through electromagnetic induction and a semiconductor device SD1 that operates with current pulses generated by this power generation element 1.

FIG. 1 representatively shows one power generation element 1. In an actual batteryless multi-turn encoder, however, a plurality of coils as a plurality of power generation elements 1 are arranged around a rotation shaft with a phase angle being shifted. As a magnet rotates with the rotation shaft, an orientation of magnetic field varies and hence a current pulse is generated in power generation element 1 through electromagnetic induction. As charges generated by power generation element 1 are stored in a capacitive element for power storage in semiconductor device SD1, the current pulse is converted to a voltage pulse. Since the plurality of power generation elements 1 are arranged at phase angles different from one another, current pulses are generated at different angles of rotation. As will be described later, a digital processing circuit 6 distinguishes the number of rotations and a direction of rotation of the rotation shaft based on the number of times of generated current pulses, a position of the power generation element, and the orientation of current pulses.

In the present disclosure, current pulses generated by power generation element 1 and voltage pulses resulting from conversion of the former are collectively referred to as power generation pulses.

Semiconductor device SD1 includes rectification circuits 101 and 201, capacitive elements 102 and 202 for storage of electric power, voltage determination circuits 103 and 203, charge amount determination circuits 104 and 204, reference voltage generation circuits 105 and 205, a selection circuit 2, a constant voltage circuit 3, a power on reset (POR) circuit 4, an oscillation circuit 5, digital processing circuit 6, and a non-volatile memory 7.

Voltage determination circuit 103 and charge amount determination circuit 104 make up a determination circuit 130 to determine whether or not an amount of power generation by power generation element 1 is sufficient. Voltage determination circuit 203 and charge amount determination circuit 204 make up a determination circuit 230 to determine whether or not the amount of power generation by power generation element 1 is sufficient.

Power generation element 1 is connected to rectification circuit 101 and rectification circuit 201. Rectification circuit 101 and rectification circuit 201 are connected to power generation element 1 as being reverse to each other in direction of rectification. Output from rectification circuit 101 is stored in capacitive element 102 and output from rectification circuit 201 is stored in capacitive element 202. Therefore, depending on a polarity of current pulses generated by power generation element 1, charges are accumulated in one of capacitive elements 102 and 202 and a voltage is generated.

Specifically, in an example in FIG. 1, rectification circuit 101 includes diodes 101A and 101B. A first end 1A of the coil as power generation element 1 is connected to a high-potential-side node 120 of capacitive element 102 with forward diode 101A being interposed. A second end 1B of the coil as power generation element 1 is connected to a low-potential-side node of capacitive element 102, that is, a ground GND, with a backward diode 101B being interposed.

Similarly, rectification circuit 201 includes diodes 201A and 201B. First end 1A of the coil as power generation element 1 is connected to a low-potential-side node of capacitive element 202, that is, ground GND, with backward diode 201B being interposed. Second end 1B of the coil as power generation element 1 is connected to a high-potential-side node 220 of capacitive element 202 with forward diode 201A being interposed.

A voltage Vpls1 at high-potential-side node 120 of capacitive element 102 is inputted to selection circuit 2, voltage determination circuit 103, charge amount determination circuit 104, and reference voltage generation circuit 105. A voltage Vpls2 at high-potential-side node 220 of capacitive element 202 is inputted to selection circuit 2, voltage determination circuit 203, charge amount determination circuit 204, and reference voltage generation circuit 205.

Reference voltage generation circuit 105 generates based on voltage Vpls1 of capacitive element 102, a constant reference voltage Vref1 independent of magnitude of voltage Vpls1. Generated reference voltage Vref1 is inputted to voltage determination circuit 103 and charge amount determination circuit 104. Similarly, reference voltage generation circuit 205 generates based on voltage Vpls2 of capacitive element 202, a constant reference voltage Vref2 independent of magnitude of voltage Vpls2. Generated reference voltage Vref2 is inputted to voltage determination circuit 203 and charge amount determination circuit 204.

Voltage determination circuit 103 determines whether or not a first determination condition that voltage Vpls1 of capacitive element 102 has exceeded a first criterion value is satisfied. Whether or not a voltage level of voltage Vpls1 of capacitive element 102 is sufficient for start of a process in digital processing circuit 6 is thus determined. Voltage determination circuit 103 outputs a result of determination to selection circuit 2 and digital processing circuit 6, as a determination signal Vdet1. Similarly, voltage determination circuit 203 determines whether or not the first determination condition that voltage Vpls2 of capacitive element 202 has exceeded the first criterion value is satisfied. Whether or not a voltage level of voltage Vpls2 of capacitive element 202 is sufficient for start of a process in digital processing circuit 6 is thus determined. Voltage determination circuit 203 outputs a result of determination to selection circuit 2 and digital processing circuit 6, as a determination signal Vdet2.

Selection circuit 2 selects one voltage that has reached the sufficient voltage level from voltages Vpls1 and Vpls2, based on determination signals Vdet1 and Vdet2. Selection circuit 2 outputs selected voltage Vpls1 or Vpls2 to constant voltage circuit 3.

Voltage Vpls1 of capacitive element 102 and reference voltage Vref1 are inputted to charge amount determination circuit 104 and a determination timing signal Vtm1 is inputted thereto from digital processing circuit 6. Charge amount determination circuit 104 determines whether or not a second determination condition that the amount of charges accumulated in capacitive element 102 has exceeded a second criterion value at the timing when determination timing signal Vtm1 is activated (for example, attains to a high level) is satisfied. Whether or not the amount of charges accumulated in capacitive element 102 is sufficient for a subsequent process in digital processing circuit 6 is thus determined. When charge amount determination circuit 104 determines that the amount of charges in capacitive element 102 is insufficient (that is, the second determination condition is not satisfied), it outputs a suspension signal Vstop1 exhibiting an active state (for example, the high level) to digital processing circuit 6.

Similarly, voltage Vpls2 of capacitive element 202 and reference voltage Vref2 are inputted to charge amount determination circuit 204 and a determination timing signal Vtm2 is inputted thereto from digital processing circuit 6. Charge amount determination circuit 204 determines whether or not an amount of charges (in proportion to voltage Vpls2) in capacitive element 202 has exceeded the second criterion value at the timing of activation of determination timing signal Vtm2. Whether or not the amount of charges in capacitive element 202 is sufficient for a subsequent process in digital processing circuit 6 is thus determined. When charge amount determination circuit 204 determines that the amount of charges in capacitive element 202 is insufficient (that is, the second determination condition is not satisfied), it outputs a suspension signal Vstop2 exhibiting the active state (for example, the high level) to digital processing circuit 6.

Constant voltage circuit 3 generates a supply voltage Vdig having a constant value to be used in POR circuit 4, oscillation circuit 5, digital processing circuit 6, and non-volatile memory 7, from voltage Vpls1 or Vpls2 selected by selection circuit 2. Constant voltage circuit 3 is, for example, a low drop out (LDO) circuit.

POR circuit 4 cancels a reset signal RST when supply voltage Vdig outputted from constant voltage circuit 3 attains to a minimum operation supply voltage.

Oscillation circuit 5 supplies a clock signal CLK to digital processing circuit 6 and non-volatile memory 7. A configuration of oscillation circuit 5 is not particularly limited. For example, the oscillation circuit may be a ring oscillator, a crystal oscillator, or a ceramic oscillator.

Digital processing circuit 6 is configured with a logic circuit. Digital processing circuit 6 outputs a write signal Write to non-volatile memory 7 and receives input of a read signal Read from non-volatile memory 7.

### [Operation of Batteryless Multi-Turn Encoder]

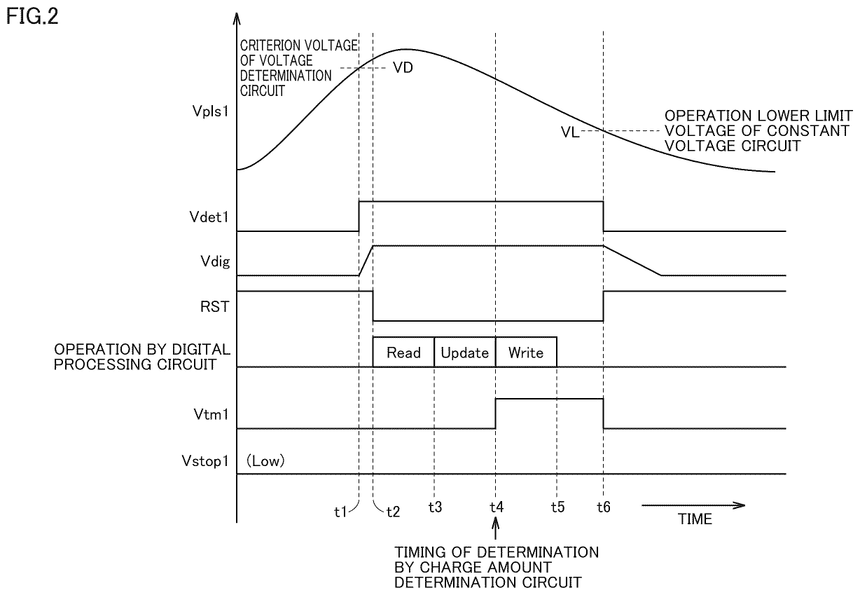

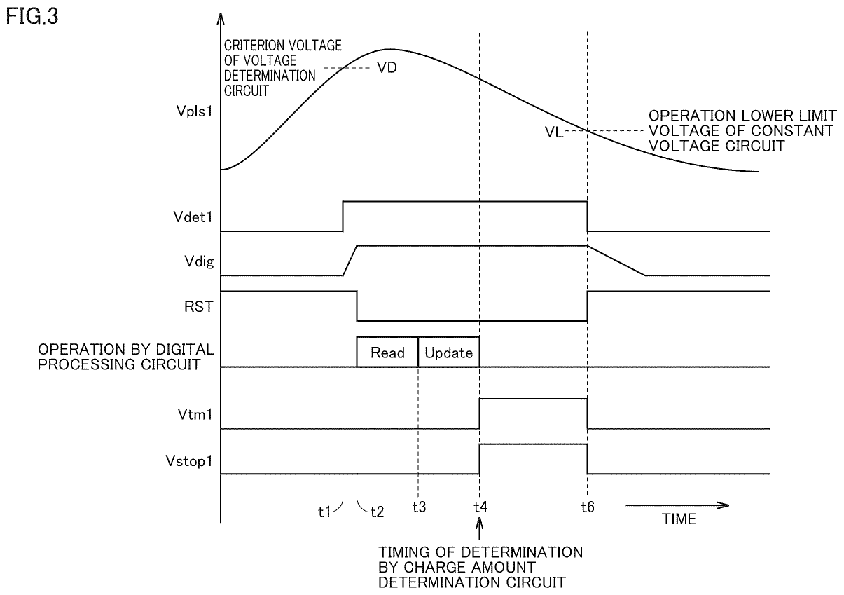

An operation of batteryless multi-turn encoder ENC1 in FIG. 1 will now be described. FIG. 2 is a timing chart showing an exemplary ordinary process in batteryless multi-turn encoder ENC1 in FIG. 1. FIG. 3 is a timing chart showing an exemplary suspension process in batteryless multi-turn encoder ENC1 in FIG. 1. FIGS. 2 and 3 correspond to each other, and corresponding elements have the same reference characters allotted.

Referring to FIGS. 1 and 2, a current generated in power generation element 1 is selectively supplied to capacitive element 102 or capacitive element 202 through rectification circuit 101 or rectification circuit 201, depending on an orientation of the same. The supplied current is accumulated as charges in the capacitive element and converted to a voltage.

For example, when a current is generated in a direction from second end 1B toward first end 1A of power generation element 1 in FIG. 1, rectification circuit 101 is rendered conductive. In this case, the current generated in power generation element 1 is supplied to capacitive element 102. In contrast, when a current is generated in a direction from first end 1A toward second end 1B of power generation element 1, rectification circuit 201 is rendered conductive. In this case, the current generated in power generation element 1 is supplied to capacitive element 202.

Voltage Vpls1 of capacitive element 102 is inputted to reference voltage generation circuit 105, where reference voltage Vref1 is generated. Voltage determination circuit 103 generates a criterion voltage VD from reference voltage Vref1 generated by reference voltage generation circuit 105, and determines whether voltage Vpls1 of capacitive element 102 is higher or lower than criterion voltage VD. A result of determination is outputted to digital processing circuit 6 as determination signal Vdet1. When voltage Vpls1 of capacitive element 102 is higher than criterion voltage VD, the high level is outputted as determination signal Vdet1, and when voltage Vpls1 is lower than criterion voltage VD, a low level is outputted as determination signal Vdet1.

In an example where criterion voltage VD is expressed as a product of Vda and Vdb (that is, VD=Vda×Vdb), comparison between voltage Vpls1 and criterion voltage VD is equivalent to comparison between Vpls1/Vda and Vdb. Therefore, voltage Vpls1 of capacitive element 102 as it is does not have to be compared.

Similarly, voltage Vpls2 of capacitive element 202 is inputted to reference voltage generation circuit 205, where reference voltage Vref2 is generated. Voltage determination circuit 203 generates criterion voltage VD from reference voltage Vref2 generated by reference voltage generation circuit 205, and determines whether Vpls2 is higher or lower than criterion voltage VD. A result of determination is outputted to digital processing circuit 6 as a determination signal Vdet2. When voltage Vpls2 of capacitive element 202 is higher than criterion voltage VD, the high level is outputted as determination signal Vdet2, and when voltage Vpls2 is lower than criterion voltage VD, the low level is outputted as determination signal Vdet2.

Though determination signals Vdet1 and Vdet2 are explained above as following a positive logic, determination signals Vdet1 and Vdet2 may follow a negative logic.

Specifically, in an example in FIG. 2, at time t1, voltage Vpls1 of capacitive element 102 exceeds criterion voltage VD, and hence determination signal Vdet1 outputted from voltage determination circuit 103 switches to the high level.

Selection circuit 2 allows selective supply of voltage Vpls1 or Vpls2 to constant voltage circuit 3 based on a logic value of each of determination signals Vdet1 and Vdet2. When determination signal Vdet1 is at the high level, voltage Vpls1 is selected, and when determination signal Vdet2 is at the high level, voltage Vpls2 is selected. Since determination signals may simultaneously attain to the high level, selection circuit 2 performs exclusive processing such as preferential selection of a determination signal that exhibits the active state earlier.

When voltage Vpls1 or Vpls2 is supplied to constant voltage circuit 3, constant voltage circuit 3 outputs voltage Vdig. In an example in FIG. 2, at time t1, voltage Vpls1 is inputted to constant voltage circuit 3, so that supply voltage Vdig rises. Voltage Vdig is supplied as a supply voltage to POR circuit 4, oscillation circuit 5, digital processing circuit 6, and non-volatile memory 7.

As supply voltage Vdig attains to a desired voltage at time t2 that follows, POR circuit 4 cancels reset signal RST. In the example in FIG. 2, reset signal RST switches from the high level to the low level. Oscillation circuit 5, digital processing circuit 6, and non-volatile memory 7 thus become operable, and the process is started.

A series of processes to be performed in the batteryless multi-turn encoder will briefly be described as below. Initially, digital processing circuit 6 counts the number of times of generation of current pulses each time a current pulse is generated in power generation element 1, and sets an orientation of the current pulse based on determination signals Vdet1 and Vdet2. Digital processing circuit 6 then distinguishes a rotation speed and a direction of rotation (which will collectively be referred to as a rotation state below) of a target of observation based on such information. Digital processing circuit 6 then has a result of distinction of the rotation state stored in non-volatile memory 7.

In order to perform the process above, as the process is started at time t2, digital processing circuit 6 initially reads information on a previous rotation state from non-volatile memory 7 (Read) during a period from time t2 until time 13.

During a period from time 13 until time 14 that follows, digital processing circuit 6 distinguishes the current rotation state based on the previous rotation state that has been read and determination signals Vdet1 and Vdet2 and updates the rotation state (Update).

When determination signal Vdet1 is valid at time t4 when update of the rotation state is completed, digital processing circuit 6 transmits determination timing signal Vtm1 in the active state (high level) to charge amount determination circuit 104.

Charge amount determination circuit 104 that has received activated determination timing signal Vtm1 determines whether or not charges stored in capacitive element 102 at this time point are equal to or larger than a criterion value. When the amount of charges in capacitive element 102 is equal to or larger than the criterion value, charge amount determination circuit 104 sets suspension signal Vstop1 to the low level, and when the amount of charges in capacitive element 102 is smaller than the criterion value, it sets suspension signal Vstop1 to the high level. The criterion value for charge amount determination circuit 104 is set based on the amount of charges necessary for a write process for write in non-volatile memory 7.

When relation between the amount of charges in capacitive element 102 and voltage Vpls1 of capacitive element 102 has been known in advance, a value converted to a voltage may be employed as the criterion value. For example, when a capacitance C of capacitive element 102 is constant independently of voltage Vpls1, the amount of charges is expressed as C×Vpls1. In charge amount determination circuits 104 and 204 in the present embodiment, the criterion value converted to the voltage is set based on reference voltages Vref1 and Vref2.

Alternatively, instead of digital processing circuit 6 sending determination timing signal Vtm1 to charge amount determination circuit 104, charge amount determination circuit 104 may constantly compare the amount of charges in capacitive element 102 and the criterion value with each other, and may constantly transmit a result of comparison to digital processing circuit 6. In this case, digital processing circuit 6 uses the result of determination received at the timing (time t4) of completion of update of the rotation state.

Digital processing circuit 6 determines that charges necessary for a subsequent process have been stored in capacitive element 102 when suspension signal Vstop1 is at the low level. In this case, digital processing circuit 6 writes updated data (that is, information on the rotation state) in non-volatile memory 7 (Write) during a period from time t4 to time 15 that follows and quits the series of processes.

When voltage Vpls1 of capacitive element 102 becomes equal to or lower than an operation lower limit voltage VL of constant voltage circuit 3 at time t6 after the series of processes ends, supply voltage Vdig outputted from constant voltage circuit 3 lowers. Reset signal RST thus attains to the high level and various circuits are reset.

When suspension signal Vstop1 is at the high level at time t4 as shown in FIG. 3, on the other hand, digital processing circuit 6 determines that charges necessary for the subsequent process have not been stored in capacitive element 102. In this case, digital processing circuit 6 performs a suspension process without writing updated data in non-volatile memory 7.

A process when determination signal Vdet2 is valid is also similar to the above. In this case, at time t4 of completion of update of the rotation state, digital processing circuit 6 transmits determination timing signal Vtm2 in the active state (high level) to charge amount determination circuit 204. In response to determination timing signal Vtm2, whether or not charges stored in capacitive element 202 at this time point are equal to or larger than the criterion value is determined. Charge amount determination circuit 204 sets suspension signal Vstop2 to the low level when the amount of charges in capacitive element 202 is equal to or larger than the criterion value, and sets suspension signal Vstop2 to the high level when the amount of charges in capacitive element 202 is smaller than the criterion value. When suspension signal Vstop2 is at the low level, digital processing circuit 6 writes updated data in non-volatile memory 7 and quits the series of processes. When suspension signal Vstop2 is at the high level, on the other hand, digital processing circuit 6 performs the suspension process not to write the updated data in non-volatile memory 7.

The fact that the suspension process is performed without the updated data being written in non-volatile memory 7 is equivalent to omission of necessary pulse detection. In such a case, a correction algorithm to correct a rotation position has been known, as described, for example, in Japanese Patent No. 5769879 (PTL 1) described previously. Thus, even when pulse detection is omitted, the number of rotations can be counted without being missed, based on the corrected rotation position. Furthermore, in the suspension process, error information indicating occurrence of an error is desirably written in non-volatile memory 7. The error information can be used as information effective for correction of the rotation position on the occurrence of omission of pulses, and it can improve accuracy of correction.

As set forth above, the process can be completed without abend, by determining whether or not necessary charges are sufficient in the middle of the process without starting the process after charges necessary for all processes are stored.

### Effect in First Embodiment

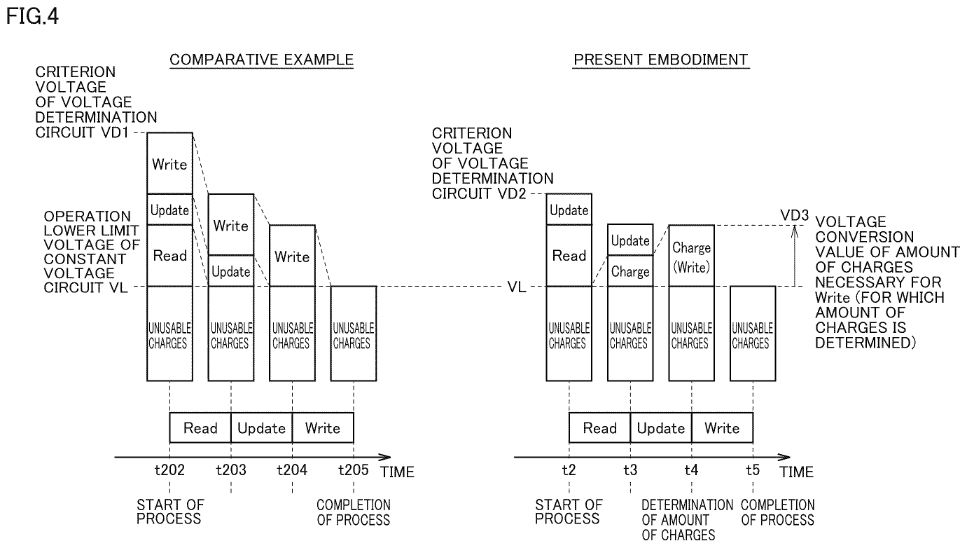

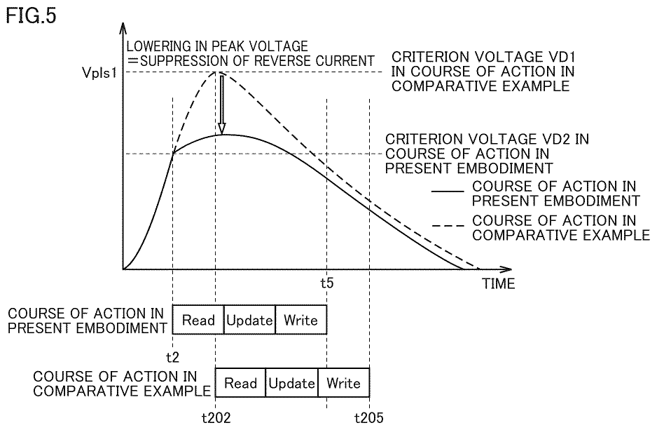

An effect in the first embodiment will be described below as compared with a comparative example with reference to FIGS. 4 and 5.

FIG. 4 is a diagram conceptually showing an amount of charges accumulated in capacitive elements 102 and 202 at the time of start and end of each of read, update, and write processes.

FIG. 4 expresses an amount of charges necessary for a reading process as Read, expresses an amount of charges necessary for an update process as Update, and expresses an amount of charges necessary for a write process as Write. An amount of charges generated after the process is started is expressed as Charge.

Charges corresponding to operation lower limit voltage VL of constant voltage circuit 3 are unusable. These unusable charges are expressed as a product of a capacitance of capacitive elements 102 and 202 and operation lower limit voltage VL of constant voltage circuit 3.

In the comparative example, the process is started after storage of charges necessary for all of the read, update, and write processes is confirmed. In this case, a criterion voltage VD1 for voltage determination circuits 103 and 203 is determined by (the operation lower limit voltage of the constant voltage circuit)+(charges necessary for all processes)×(the capacitance of the capacitive elements) and cannot be equal to or lower than that.

Furthermore, in the comparative example, a lower limit amount of charges that allow all processes is an amount of charges when criterion voltage VD1 is equal to peak values of voltages Vpls1 and Vpls2 of capacitive elements 102 and 202. In this case, there are no charges supplied after determination of the voltage, and charges are consumed in each process after determination of the voltage. Therefore, voltages Vpls1 and Vpls2 of capacitive elements 102 and 202 gradually lower and reach operation lower limit voltage VL of constant voltage circuit 3 at the time point of completion of all processes.

In the present embodiment, on the other hand, a criterion voltage VD2 for voltage determination circuits 103 and 203 may be defined as (the operation lower limit voltage of the constant voltage circuit)+(charges necessary for read and update)×(the capacitance of the capacitive elements). In other words, the criterion voltage for voltage determination circuits 103 and 203 can be lowered by a voltage conversion value VD3 of the amount of charges necessary for the write process. In order to complete the process up to the write process, charges necessary for the write process should be supplied from power generation element 1 before start of the write process after start of the process. Charge amount determination circuits 104 and 204 determine whether or not charges in an amount necessary for the write process (Charge) have been supplied to capacitive elements 102 and 202.

The present embodiment is on the premise that the read process and the update process are correctly performed. When no problem arises in spite of abend, however, criterion voltage VD2 can be lowered to operation lower limit voltage VL of constant voltage circuit 3. Even when voltages Vpls1 and Vpls2 of capacitive elements 102 and 202 become lower than operation lower limit voltage VL in the middle of the read process or the update process, data in digital processing circuit 6 is simply reset and abnormal data is not written in non-volatile memory 7.

FIG. 5 is a diagram conceptually showing change over time in voltage Vpls1 of capacitive element 102. Voltage Vpls1 shown in FIG. 5 corresponds to a case of an amount of charges being larger than a minimum amount of charges shown in FIG. 4.

In the comparative example shown with a dashed line, the amount of charges that allow all processes is stored in capacitive element 102 at time t202 of start of the process. In this case, a peak value of voltage Vpls1 of capacitive element 102 is equal to or larger than criterion voltage VD1 for voltage determination circuit 103.

In the present embodiment shown with a solid line, on the other hand, criterion voltage VD2 for voltage determination circuit 103 can be lower than criterion voltage VD1 in the comparative example. Therefore, the process is started at time t2 before the peak value is attained to, that is, in the middle of power generation by power generation element 1. Since the peak value of a power generation voltage can consequently be lowered, a reverse current generated in the coil as power generation element 1 can be suppressed.

As set forth above, in batteryless multi-turn encoder ENC1 in the present embodiment, whether or not charges in capacitive elements 102 and 202 are sufficient for performing the subsequent process is determined in the middle of the series of processes. The series of processes can thus be started earlier, and increase in voltage of capacitive elements 102 and 202 can be suppressed. Since the voltage applied to the coil as power generation element 1 can consequently be suppressed, a reverse voltage generated in the coil can be suppressed and effective generated charges can be increased. Therefore, even when power generation capability of the power generation element is relatively low, omission of detection of a power generation pulse can be prevented and the rotation state can be distinguished.

Though an example in which the amount of charges in capacitive elements 102 and 202 is determined before the write process is described in the present embodiment, the amount of charges may be determined before the read process or the update process. Since charges generated after determination of the amount of charges is not taken into consideration in determination of the amount of charges, the amount of charges is desirably determined at timing as late as possible. The amount of charges may be determined at a plurality of timings.

### [Exemplary Configuration of Various Circuits]

An exemplary configuration of reference voltage generation circuits 105 and 205, voltage determination circuits 103 and 203, charge amount determination circuits 104 and 204, selection circuit 2, constant voltage circuit 3, and POR circuit 4 in FIG. 1 will be described below. The circuit configuration shown below is merely by way of example, and limitation thereto is not intended. Any circuit configuration to perform the functions described above may be applicable.

### (Reference Voltage Generation Circuit and Voltage Determination Circuit)

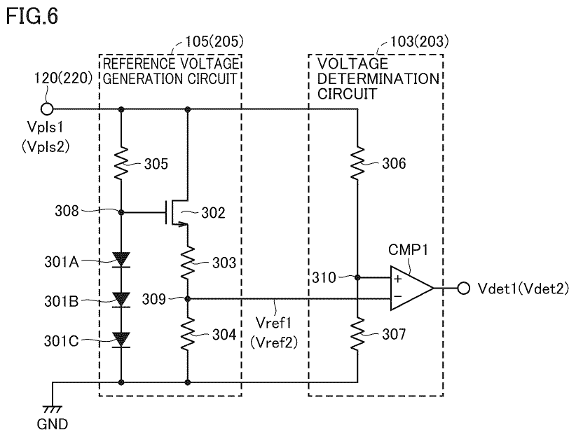

FIG. 6 is a circuit diagram showing an exemplary configuration of reference voltage generation circuit 105 and voltage determination circuit 103 in FIG. 1. Reference voltage generation circuit 205 and voltage determination circuit 203 are also similar in configuration.

Reference voltage generation circuit 105 includes a plurality of diodes 301 connected in series, an N-channel metal-oxide-semiconductor (NMOS) transistor 302, and resistive elements 303 to 305. In an example in FIG. 6, three diodes 301A to 301C are provided as the plurality of diodes 301.

NMOS transistor 302 has a drain terminal connected to high-potential-side node 120 of capacitive element 102. NMOS transistor 302 has a source terminal connected to ground GND with resistive elements 303 and 304 connected in series being interposed. NMOS transistor 302 has a gate terminal connected to high-potential-side node 120 with resistive element 305 being interposed and connected to ground GND with diodes 301A to 301C connected in series in a forward direction being interposed.

According to the configuration, a source voltage of NMOS transistor 302 is a constant voltage determined in accordance with a forward voltage of diodes 301A to 301C independently of voltage Vpls1 of high-potential-side node 120. A divided voltage resulting from division of this constant source voltage by resistive elements 303 and 304 is outputted as reference voltage Vref1 from a connection node 309 of resistive elements 303 and 304.

Voltage determination circuit 103 includes a voltage comparator CMP1 and resistive elements 306 and 307. Resistive elements 306 and 307 are connected in series between high-potential-side node 120 and ground GND. Voltage comparator CMP1 has a non-inverting input terminal connected to a connection node 310 of resistive elements 306 and 307. Reference voltage Vref1 is inputted to an inverting input terminal of voltage comparator CMP1.

According to the configuration, voltage comparator CMP1 compares a divided voltage resulting from division of voltage Vpls1 of capacitive element 102 by resistive elements 306 and 307 with reference voltage Vref1. Voltage comparator CMP1 activates determination signal Vdet1 when the divided voltage resulting from division of voltage Vpls1 is higher than reference voltage Vref1.

### (Charge Amount Determination Circuit)

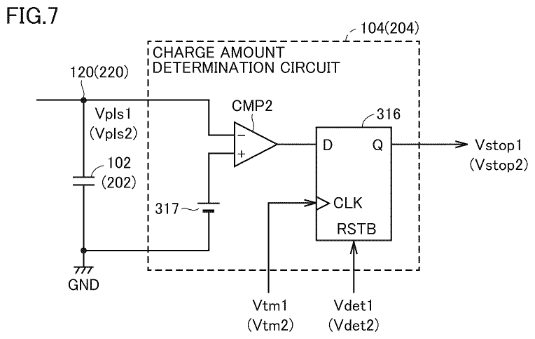

FIG. 7 is a circuit diagram showing an exemplary configuration of charge amount determination circuit 104 in FIG. 1. In FIG. 7, assuming that the amount of charges in capacitive element 102 is in proportion to the voltage, charge amount determination circuit 104 compares voltage Vpls1 of capacitive element 102 with a reference voltage 317. Charge amount determination circuit 204 is also similar in configuration.

Specifically, charge amount determination circuit 104 includes a voltage comparator CMP2, a D flip-flop 316, and reference voltage 317. Voltage comparator CMP2 has an inverting input terminal connected to high-potential-side node 120 of capacitive element 102. Reference voltage 317 is inputted to a non-inverting input terminal of voltage comparator CMP2. Reference voltage 317 is generated, for example, from reference voltage Vref1. A result of comparison by voltage comparator CMP2 is inputted to an input terminal D of D flip-flop 316. Suspension signal Vstop1 is outputted from an output terminal Q of D flip-flop 316. Determination timing signal Vtm1 is inputted to a clock terminal CLK of D flip-flop 316 and determination signal Vdet1 is inputted to an inverting reset terminal RSTB of D flip-flop 316.

According to the configuration, D flip-flop 316 holds a logic value representing the result of comparison by voltage comparator CMP2 inputted to input terminal D at timing of activation of determination timing signal Vtm1 to the high level. D flip-flop 316 outputs the held logic value from output terminal Q as suspension signal Vstop1. Therefore, when reference voltage 317 is higher than voltage Vpls1 of capacitive element 102, suspension signal Vstop1 at the high level is outputted from D flip-flop. 316. Since D flip-flop 316 is reset when determination signal Vdet1 is switched from the high level to the low level, suspension signal Vstop1 returns to the low level.

### (Selection Circuit)

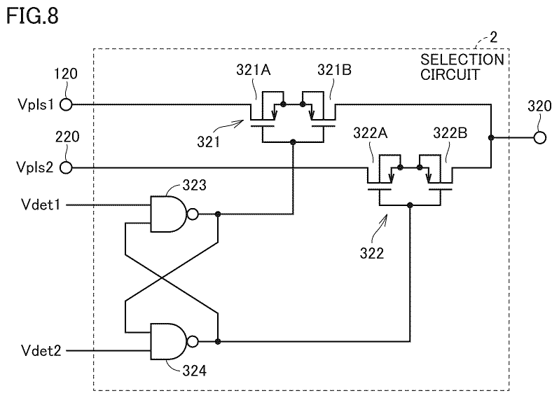

FIG. 8 is a circuit diagram showing an exemplary configuration of selection circuit 2 in FIG. 1. Referring to FIG. 8, selection circuit 2 includes bidirectional switches 321 and 322 and NAND circuits 323 and 324 which make up a flip-flop.

Bidirectional switch 321 is configured by connecting two P-channel metal-oxide semiconductor (PMOS) transistors 321A and 321B in series such that polarities thereof are reverse. Similarly, bidirectional switch 322 is configured by connecting two PMOS transistors 322A and 322B in series such that polarities thereof are reverse. An output node 320 of selection circuit 2 is connected to high-potential-side node 120 of capacitive element 102 with bidirectional switch 321 being interposed and connected to high-potential-side node 220 of capacitive element 202 with bidirectional switch 322 being interposed.

Determination signal Vdet1 is inputted to a first input terminal of NAND circuit 323. Determination signal Vdet2 is inputted to a first input terminal of NAND circuit 324. NAND circuit 323 has an output terminal connected to a second input terminal of NAND circuit 324 and connected to gate terminals of PMOS transistors 321A and 321B which make up bidirectional switch 321. NAND circuit 324 has an output terminal connected to a second input terminal of NAND circuit 323 and connected to gate terminals of PMOS transistors 322A and 322B which make up bidirectional switch 322.

According to the configuration, when determination signal Vdet1 is at the high level and determination signal Vdet2 is at the low level, an output signal from NAND circuit 323 attains to the low level and an output signal from NAND circuit 324 attains to the high level. Consequently, bidirectional switch 321 is rendered conductive and bidirectional switch 322 is rendered non-conductive, and hence voltage Vpls1 of capacitive element 102 is outputted from output node 320 of selection circuit 2.

In contrast, when determination signal Vdet1 is at the low level and determination signal Vdet2 is at the high level, the output signal from NAND circuit 323 attains to the high level and the output signal from NAND circuit 324 attains to the low level. Consequently, bidirectional switch 321 is rendered non-conductive and bidirectional switch 322 is rendered conductive, and hence voltage Vpls2 of capacitive element 202 is outputted from output node 320 of selection circuit 2.

### (Constant Voltage Circuit)

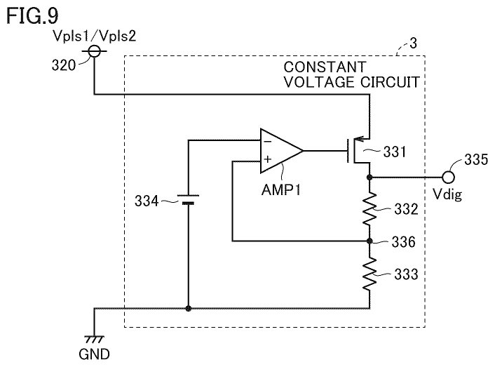

FIG. 9 is a circuit diagram showing an exemplary configuration of constant voltage circuit 3 in FIG. 1. Referring to FIG. 9, constant voltage circuit 3 includes a PMOS transistor 331, resistive elements 332 and 333, a differential amplifier AMP1, and a reference voltage 334. Reference voltage 334 may be generated by using reference voltages Vref1 and Vref2.

PMOS transistor 331 has a source terminal connected to output node 320 of selection circuit 2. PMOS transistor 331 has a drain terminal connected to an output node 335 of constant voltage circuit 3 and connected to ground GND with resistive elements 332 and 333 connected in series being interposed. Differential amplifier AMP1 has a non-inverting input terminal connected to a connection node 336 of resistive elements 332 and 333.

According to the configuration, since negative feedback is applied such that a voltage at connection node 336 is equal to reference voltage 334, supply voltage Vdig outputted from output node 335 has a constant value independent of magnitude of voltage Vpls1/Vpls2.

### (POR Circuit)

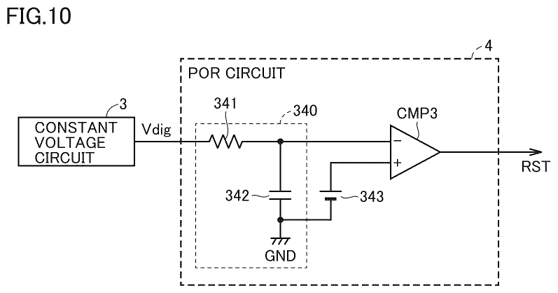

FIG. 10 is a circuit diagram showing an exemplary configuration of POR circuit 4 in FIG. 1. Referring to FIG. 10, POR circuit 4 includes a low-pass filter 340 composed of a resistive element 341 and a capacitor 342, a voltage comparator CMP3, and a reference voltage 343. Reference voltage 343 may be generated by using reference voltages Vref1 and Vref2.

As shown in FIG. 10, supply voltage Vdig outputted from constant voltage circuit 3 is inputted to an inverting input terminal of voltage comparator CMP3 through low-pass filter 340. Reference voltage 343 is inputted to a non-inverting input terminal of voltage comparator CMP3. According to such a configuration, reset signal RST is canceled when supply voltage Vdig attains to reference voltage 343. Low-pass filter 340 is provided to suppress noise and overshoot of supply voltage Vdig outputted from constant voltage circuit 3.

### Second Embodiment

### [Configuration of Batteryless Multi-Turn Encoder]

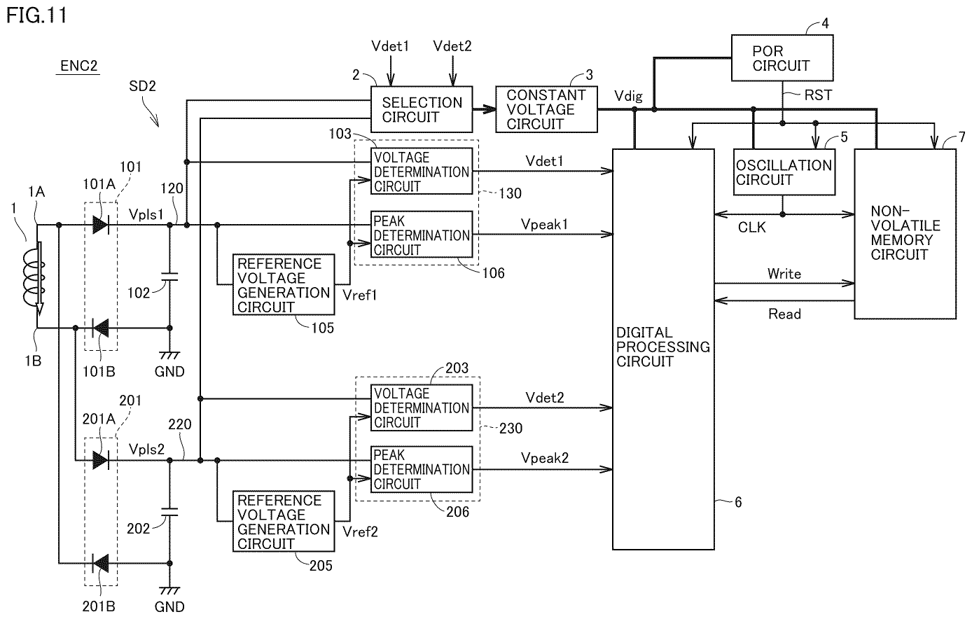

FIG. 11 is a circuit block diagram of a batteryless multi-turn encoder ENC2 according to a second embodiment. A semiconductor device SD2 of batteryless multi-turn encoder ENC2 in FIG. 11 is different from semiconductor device SD1 of batteryless multi-turn encoder ENC1 in FIG. 1 in including peak determination circuits 106 and 206 instead of charge amount determination circuits 104 and 204. Determination circuit 130 is configured with voltage determination circuit 103 and peak determination circuit 106 and determination circuit 230 is configured with voltage determination circuit 203 and peak determination circuit 206.

Voltage Vpls1 of capacitive element 102 and reference voltage Vref1 outputted from reference voltage generation circuit 105 are inputted to peak determination circuit 106. Peak determination circuit 106 determines whether or not a second determination condition that a peak value of voltage Vpls1 of capacitive element 102 attains to a criterion voltage VP is satisfied, and outputs a determination signal Vpeak1 representing a result of determination to digital processing circuit 6.

Similarly, voltage Vpls2 of capacitive element 202 and reference voltage Vref2 outputted from reference voltage generation circuit 205 are inputted to peak determination circuit 206. Peak determination circuit 206 determines whether or not a second determination condition that a peak value of voltage Vpls2 of capacitive element 202 attains to criterion voltage VP is satisfied, and outputs a determination signal Vpeak2 representing a result of determination to digital processing circuit 6.

Since FIG. 11 is otherwise similar in configuration to FIG. 1, the same or corresponding elements have the same reference characters allotted and description: thereof will not be repeated.

### [Operation of Batteryless Multi-Turn Encoder]

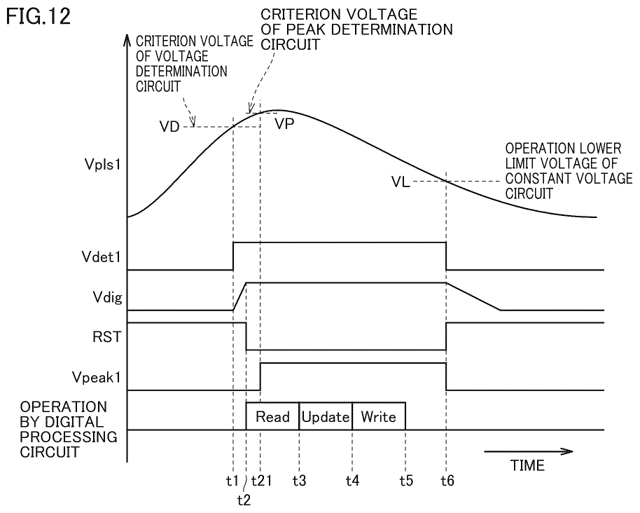

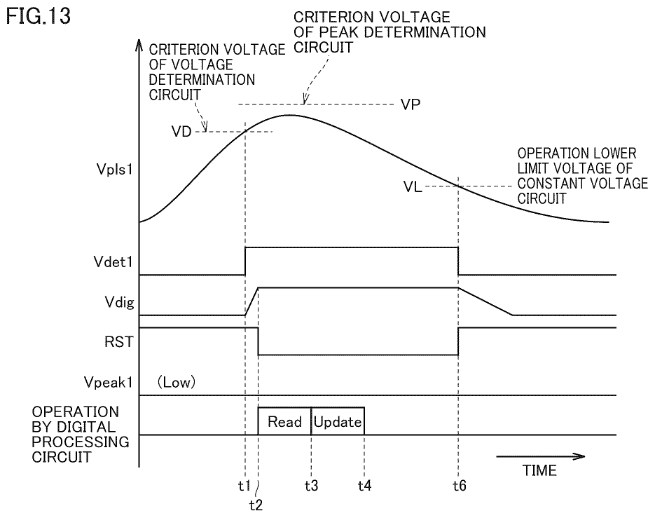

An operation of batteryless multi-turn encoder ENC2 in FIG. 11 will now be described. FIG. 12 is a timing chart showing an exemplary ordinary process in batteryless multi-turn encoder ENC2 in FIG. 11. FIG. 13 is a timing chart showing an exemplary suspension process in batteryless multi-turn encoder ENC2 in FIG. 11.

The timing charts in FIGS. 12 and 13 correspond to the respective timing charts in FIGS. 2 and 3 in the first embodiment, and they are similar in operation except for determination of the peak by peak determination circuits 106 and 206. Determination timing signals Vtm1 and Vtm2 used by charge amount determination circuits 104 and 204 in the first embodiment are not required.

Specifically, peak determination circuit 106 keeps monitoring whether or not the peak value of voltage Vpls1 of capacitive element 102 has attained to criterion voltage VP, from start of power generation by power generation element 1. More specifically, peak determination circuit 106 maintains determination signal Vpeak1 which it outputs in the active state (for example, at the high level) when the peak value of voltage Vpls1 of capacitive element 102 exceeds criterion voltage VP even once, whereas it maintains determination signal Vpeak1 in an inactive state (for example, at the low level) when the peak value never exceeds criterion voltage VP.

Actually, voltage Vpls1 of capacitive element 102 has such an upward projecting waveform that, in power generation, the voltage gradually increases and reaches the peak and thereafter gradually lowers. Therefore, when voltage Vpls1 of capacitive element 102 at the current time point at least temporarily exceeds criterion voltage VP, peak determination circuit 106 may switch determination signal Vpeak1 from the low level to the high level and thereafter maintain determination signal Vpeak1 at the high level.

An operation of peak determination circuit 206 is also similar. Specifically, peak determination circuit 206 maintains determination signal Vpeak2 which it outputs in the active state (for example, at the high level) when the peak value of voltage Vpls2 of capacitive element 202 at least temporarily exceeds criterion voltage VP, whereas it maintains determination signal Vpeak2 in the inactive state (for example, at the low level) when the peak value never exceeds criterion voltage VP.

Digital processing circuit 6 monitors determination signals Vpeak1 and Vpeak2 outputted from peak determination circuits 106 and 206 before it starts the write process. Digital processing circuit 6 starts the write process when determination signals Vpeak1 and Vpeak2 are at the high level, and does not perform the write process when they are at the low level. Timing of determination as to whether or not determination signals Vpeak1 and Vpeak2 are at the high level is desirably immediately before start of the write process. If determination is made at earlier timing and voltages Vpls1 and Vpls2 of capacitive elements 102 and 202 attain to the peak after the determination, charges generated by power generation element 1 during a period from the determination until the voltages attain to the peak are disadvantageously not taken into consideration.

In the example in FIG. 12, voltage Vpls1 of capacitive element 102 attains to criterion voltage VP at time t21, and hence peak determination circuit 106 switches determination signal Vpeak1 from the low level to the high level. Thereafter, determination signal Vpeak1 is maintained at the high level until voltage Vpls1 of capacitive element 102 lowers to operation lower limit voltage VL of constant voltage circuit 3 at time t6.

When digital processing circuit 6 confirms after the end of the update process that determination signal Vpeak1 is at the high level at time t4 immediately before start of the write process, it starts the write process.

In the example in FIG. 13, after power generation by power generation element 1 is started, voltage Vpls1 of capacitive element 102 never attains to criterion voltage VP and hence peak determination circuit 106 maintains determination signal Vpeak1 at the low (Low) level.

When digital processing circuit 6 confirms after the end of the update process that determination signal Vpeak1 is at the low level at time 14 immediately before start of the write process, it performs the suspension process without starting the write process.

### Effect and Modification

When voltages Vpls1 and Vpls2 of capacitive elements 102 and 202 exhibit such waveforms as smoothly increasing and attaining to the peak and thereafter smoothly decreasing, an effect as in the first embodiment can be obtained with the method above. When waveforms of voltages Vpls1 and Vpls2 repeat increase and decrease, however, whether or not the amount of power generation is sufficient for completion of the series of processes may not be determined only based on the peak value. Digital processing circuit 6 then desirably includes a mechanism to detect a write error.

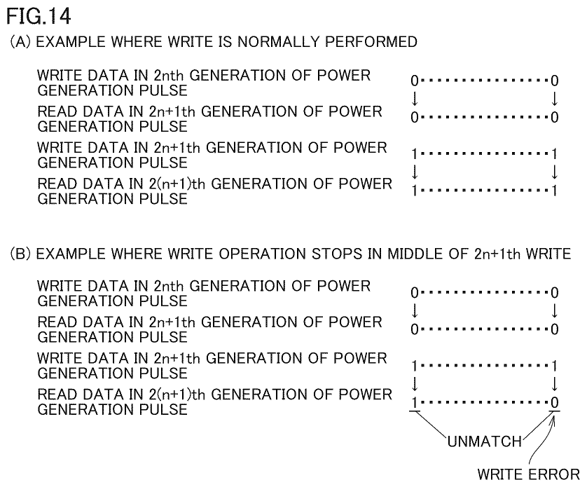

FIG. 14 is a diagram for illustrating an exemplary mechanism to detect a write error. An error detection bit is provided at the beginning and the end of data to be written in non-volatile memory 7 in the write process. Digital processing circuit 6 writes “0” into the first bit and the last bit of write data in even-number (2n)-th generation of the power generation pulse. Digital processing circuit 6 writes “1” into the first bit and the last bit of write data in odd-number (2n+1)-th generation of the power generation pulse.

Referring to FIG. 14(A), when write is normally performed, the first bit and the last bit of read data in 2n+1th generation of the power generation pulse are “0” and the first bit and the last bit of read data in 2(n+1)th generation of the power generation pulse are “1”.

Referring to FIG. 14(B), when a write operation stops in the middle of 2n+1th write, “1” is written as a bit for error detection at the beginning of the write data, whereas “1” is not written as a bit for error detection at the end of the write data. Therefore, the first bit and the last bit of the read data in 2(n+1)th generation of the power generation pulse do not match with each other. Since the fact that the write operation has not been completed to the end can thus be distinguished, an error process can be performed.

The mechanism to detect the write error may be incorporated in digital processing circuit 6 of semiconductor device SD1 in the first embodiment for safety, in preparation for such a situation as unexpected consumption of charges.

### [Exemplary Configuration of Peak Determination Circuit]

An exemplary configuration of peak determination circuits 106 and 206 in FIG. 11 will be described below. The circuit configuration shown below is merely by way of example, and limitation thereto is not intended. Any circuit configuration to perform the functions described above may be applicable.

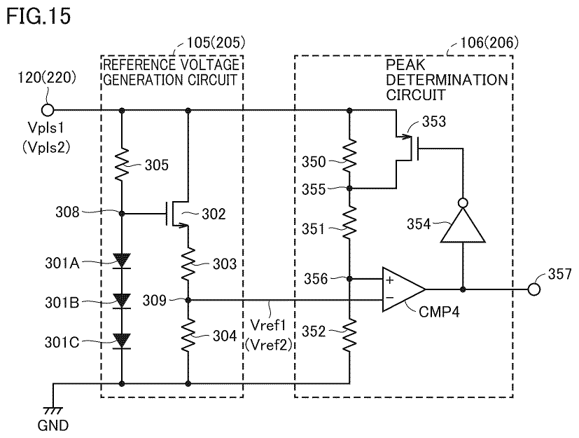

FIG. 15 is a circuit diagram showing an exemplary configuration of peak determination circuit 106 in FIG. 11. In peak determination circuit 106 shown in FIG. 15, a threshold value of a voltage comparator has hysteresis. Peak determination circuit 206 is also similar in configuration.

Specifically, peak determination circuit 206 includes resistive elements 350, 351, and 352, a voltage comparator CMP4, a NOT circuit 354, and a PMOS transistor 353, Resistive elements 350, 351, and 352 are connected in series in this order between high-potential-side node 120 of capacitive element 102 and ground GND. Voltage comparator CMP4 has a non-inverting input terminal connected to a connection node 356 of resistive element 351 and resistive element 352. Reference voltage Vref1 is inputted to an inverting input terminal of voltage comparator CMP4. PMOS transistor 353 is connected in parallel to resistive element 350. Voltage comparator CMP4 has an output terminal connected to an output node 357 of peak determination circuit 106 and connected to a gate terminal of PMOS transistor 353 with NOT circuit 354 being interposed.

According to the configuration, when voltage Vpls1 is relatively low, output from voltage comparator CMP4 is at the low level and PMOS transistor 353 is in an off state. Voltage comparator CMP4 compares voltage Vpls1 with a first threshold value Vref1×(r0+r1+r2)/r2, where r0, r1, and r2 represent resistance values of resistive elements 350, 351, and 352, respectively.

When voltage Vpls1 then exceeds the first threshold value, output from voltage comparator CMP4 attains to the high level and PMOS transistor 353 is set to an on state. In this case, voltage comparator CMP4 compares voltage Vpls1 with a second threshold value Vref1×(r1+r2)/f2. Since the second threshold value is smaller than the first threshold value, a state of the high level of output from voltage comparator CMP4 is maintained. A similar effect is obtained also by addition of a latch circuit at an output of voltage comparator CMP4.

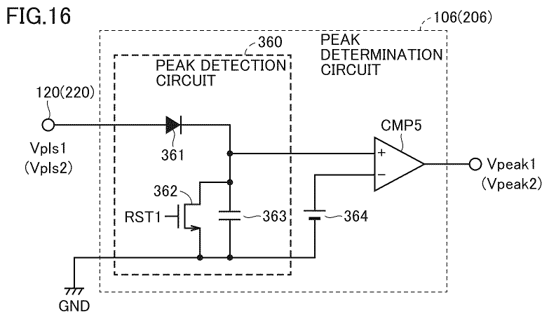

FIG. 16 is a circuit diagram showing another exemplary configuration of peak determination circuit 106 in FIG. 11. Peak determination circuit 106 in FIG. 16 detects a height of the peak of voltage Vpls2 with a peak detection circuit and compares the detected height of the peak with a reference voltage. Peak determination circuit 206 is also similar in configuration.

Specifically, peak determination circuit 106 includes a peak detection circuit 360, a voltage comparator CMP5, and a reference voltage 364. Peak detection circuit 360 includes a diode 361, an NMOS transistor 362, and a capacitor 363. Reference voltage 364 may be generated by using reference voltages Vref1 and Vref2.

Diode 361 has an anode connected to high-potential-side node 120 of capacitive element 102 and has a cathode connected to ground GND with capacitor 363 being interposed. According to this configuration, voltage Vpls1 is held in capacitor 363 until voltage Vpls1 attains to the peak. As a reset signal RST1 is inputted to a gate terminal of NMOS transistor 362, the voltage of capacitor 363 is reset. Voltage comparator CMP5 compares the voltage of capacitor 363 with reference voltage 364, and when the voltage of capacitor 363 exceeds reference voltage 364, it sets determination signal Vpeak1 to the high level.

### Third Embodiment

### [Configuration of Batteryless Multi-Turn Encoder]

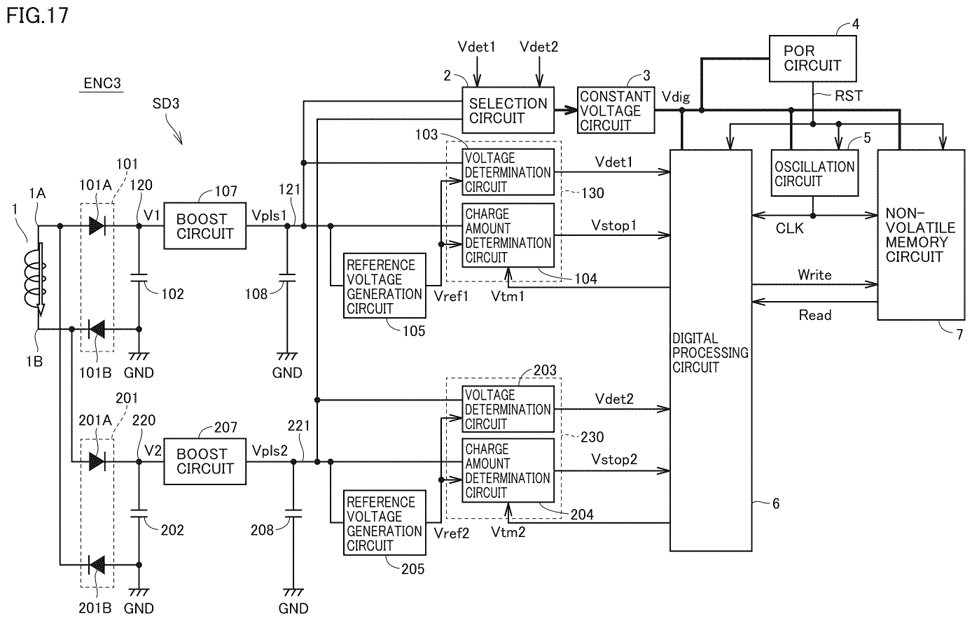

FIG. 17 is a circuit block diagram of a batteryless multi-turn encoder ENC3 according to a third embodiment. A semiconductor device SD3 of batteryless multi-turn encoder ENC3 in FIG. 17 is different from semiconductor device SD1 of batteryless multi-turn encoder ENC1 in FIG. 1 in points below.

Initially, a boost circuit 107 is provided between a connection node 121 where selection circuit 2, voltage determination circuit 103, charge amount determination circuit 104, and reference voltage generation circuit 105 are connected in common and high-potential-side node 120 of capacitive element 102. Similarly, a boost circuit 207 is provided between a connection node 221 where selection circuit 2, voltage determination circuit 203, charge amount determination circuit 204, and reference voltage generation circuit 205 are connected in common and high-potential-side node 220 of capacitive element 202.

Furthermore, another capacitive element 108 is connected between connection node 121 and ground GND. Similarly, another capacitive element 208 is connected between connection node 221 and ground GND.

Boost circuit 107 generates voltage Vpls1 by boosting a voltage V1 of capacitive element 102. Voltage Vpls1 is stored in capacitive element 108 as charges. Constant voltage circuit 3 generates supply voltage Vdig from voltage Vpls1 of capacitive element 108. Similarly, boost circuit 207 generates voltage Vpls2 by boosting a voltage V2 of capacitive element 202. Voltage Vpls2 is stored in capacitive element 208 as charges. Constant voltage circuit 3 generates supply voltage Vdig from voltage Vpls2 of capacitive element 208.

A configuration of boost circuits 107 and 207 is not particularly limited. For example, an insulated or non-insulated DC/DC converter may be connected with a buffer amplifier to convert a current to a voltage being interposed.

Since FIG. 17 is otherwise similar in configuration to FIG. 1, the same or corresponding elements have the same reference characters allotted and description thereof will not be repeated. Boost circuits 107 and 207 and capacitive elements 108 and 208 in FIG. 17 can also be combined with semiconductor device SD2 of batteryless multi-turn encoder ENC2 in the second embodiment shown in FIG. 11.

### [Operation of Batteryless Multi-Turn Encoder]

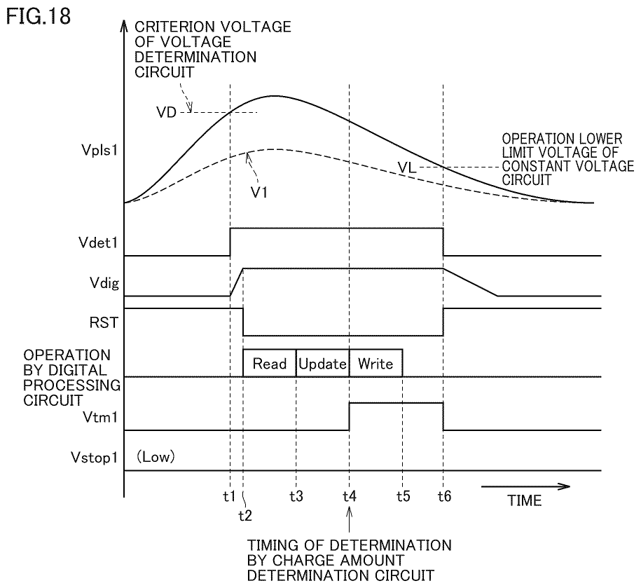

FIG. 18 is a timing chart showing an exemplary ordinary process in batteryless multi-turn encoder ENC3 in FIG. 17. Though the timing chart in FIG. 18 is different from the timing chart in FIG. 2 in that voltage Vpls1 obtained by boost of voltage V1 of capacitive element 102 is used to drive constant voltage circuit 3, FIG. 18 is otherwise similar to FIG. 2. Elements in FIG. 18 the same as or corresponding to those in FIG. 2 have the same reference characters allotted.

Specifically, as boosted voltage Vpls1 attains to criterion voltage VD of voltage determination circuit 103, constant voltage circuit 3 starts operating. Digital processing circuit 6 thus performs the read process and the update process.

Furthermore, at the timing (time t4) of switching of determination timing signal Vtm1 from the low level to the high level, charge amount determination circuit 104 determines whether or not the amount of charges corresponding to boosted voltage Vpls1 is equal to or larger than a criterion value. Consequently, when the amount of charges corresponding to boosted voltage Vpls1 is equal to or larger than the criterion value, digital processing circuit 6 performs the write process and completes the series of processes. When the amount of charges corresponding to boosted voltage Vpls1 is smaller than the criterion value, on the other hand, digital processing circuit 6 performs the suspension process without writing updated data in non-volatile memory 7 as described with reference to FIG. 3.

Thus, whether or not voltages Vpls1 and Vpls2 obtained by boosting voltages V1 and V2 of capacitive elements 102 and 202 directly connected to power generation element 1, rather than voltages V1 and V2, are sufficient for starting the read process is determined, and whether or not they correspond to the amount of charges sufficient for performing the write process is determined.

### Effect of Third Embodiment

As set forth above, according to batteryless multi-turn encoder ENC3 in the third embodiment, even when voltages V1 and V2 of capacitive elements 102 and 202 directly connected to power generation element 1 are low, boosted voltages Vpls1 and Vpls2 sufficient for driving constant voltage circuit 3 are obtained and digital processing circuit 6 can start the process. Since the voltage applied to power generation element 1 can consequently be suppressed, a current in the reverse direction generated in power generation element 1 can be suppressed and more charges can be used.

Even when the capacitances of capacitive elements 108 and 208 on an output side of boost circuits 107 and 207 are lowered, the voltage applied to power generation element 1 does not become high. Therefore, the capacitances of capacitive elements 108 and 208 can be lowered. Since “unusable charges,” that is, (the capacitance of the capacitive elements)×(the operation lower limit voltage of the constant voltage circuit), described with reference to FIG. 4 can thus be reduced, more charges can be used. Attention, however, should be paid to loss of a considerable amount of charges in boost circuits 107 and 207 depending on power conversion efficiency of boost circuits 107 and 207. Therefore, when an increment of the amount of charges usable owing to the effect above is larger than a decrement of charges in boost circuits 107 and 207, charges generated by power generation element 1 can more efficiently be used.

### Fourth Embodiment

### [Configuration of Batteryless Multi-Turn Encoder]

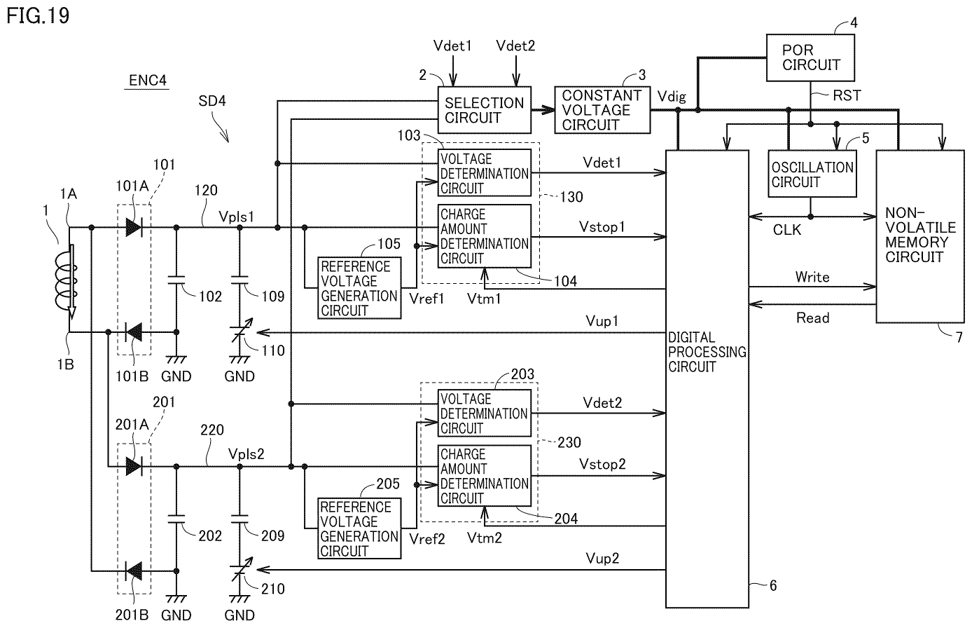

FIG. 19 is a circuit block diagram of a batteryless multi-turn encoder ENC4 according to a fourth embodiment. In the fourth embodiment, an exemplary simplified boost circuit including a capacitive element is shown.

Specifically, a semiconductor device SD4 of batteryless multi-turn encoder ENC4 in FIG. 19 is different from semiconductor device SD1 of batteryless multi-turn encoder ENC1 in FIG. 1 in further including other capacitive elements 109 and 209 and variable voltage generators 110 and 210.

Capacitive element 109 has one end connected to high-potential-side node 120 of capacitive element 102 and the other end connected to ground GND with variable voltage generator 110 being interposed. In other words, a serially connected body of capacitive element 109 and variable voltage generator 110 is connected in parallel to capacitive element 102. Similarly, capacitive element 209 has one end connected to high-potential-side node 220 of capacitive element 202 and the other end connected to ground GND with variable voltage generator 210 being interposed. In other words, a serially connected body of capacitive element 209 and variable voltage generator 210 is connected in parallel to capacitive element 202.

Variable voltage generator 110 increases an output voltage when a boost signal Vup1 received from digital processing circuit 6 is set to the active state (for example, the high level). Similarly, variable voltage generator 210 increases an output voltage when a boost signal Vup2 received from digital processing circuit 6 is set to the active state (for example, the high level).

Since FIG. 19 is otherwise similar in configuration to FIG. 1, the same or corresponding elements have the same reference characters allotted and description thereof will not be repeated. Capacitive elements 109 and 209 and variable voltage generators 110 and 210 in FIG. 19 can also be combined with semiconductor device SD2 of batteryless multi-turn encoder ENC2 in the second embodiment shown in FIG. 11.

### [Operation of Batteryless Multi-Turn Encoder]

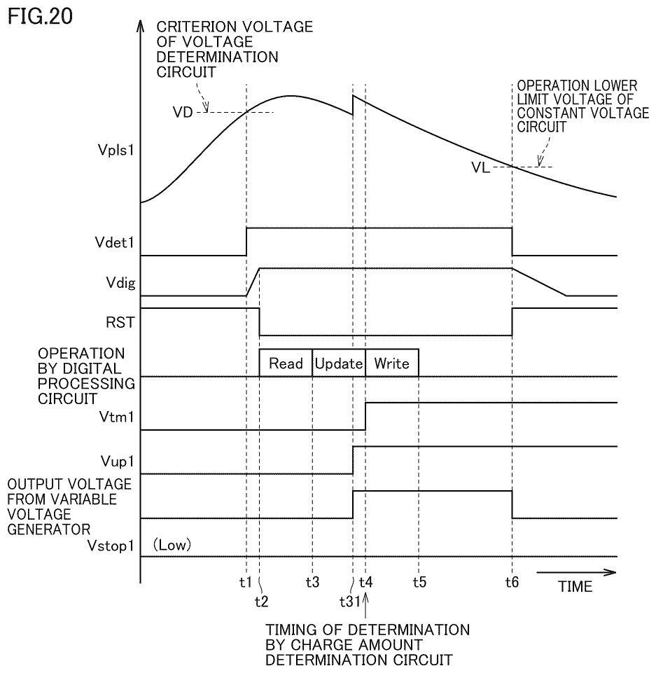

FIG. 20 is a timing chart showing an exemplary ordinary process in batteryless multi-turn encoder ENC4 in FIG. 19. Since the timing chart in FIG. 20 corresponds to the timing chart in the first embodiment in FIG. 2, corresponding elements have reference characters the same as those in FIG. 2 allotted.

As in the first embodiment, when current pulses are generated in power generation element 1, a path of flow of a current is selectively determined by an orientation of current pulses and how rectification circuits 101 and 201 work. When the current flows in the orientation in which rectification circuit 101 is active, charges are supplied to capacitive elements 102 and 109 and voltage Vpls1 at high-potential-side node 120 increases. At this time, the output voltage from variable voltage generator 110 is kept at a GND level or at a low voltage.

When voltage Vpls1 at high-potential-side node 120 attains to criterion voltage VD at time t1, voltage determination circuit 103 switches determination signal Vdet1 from the low level to the high level as in the first embodiment. Selection circuit 2 thus supplies voltage Vpls1 to constant voltage circuit 3 and constant voltage circuit 3 generates supply voltage Vdig from supplied voltage Vpls1.

When reset signal RST is canceled as supply voltage Vdig attains to a defined voltage at time t2, digital processing circuit 6 starts the series of processes (read, update, and write) as in the first embodiment.

Digital processing circuit 6 switches boost signal Vup1 from the low level to the high level at time t31 before time t4 of switching of determination timing signal Vtm1 to be transmitted to charge amount determination circuit 104 from the low level to the high level. The output voltage from variable voltage generator 110 thus increases, and with this increase in output voltage, voltage Vpls1 at high-potential-side node 120 increases. Therefore, the amount of charges that can be processed by digital processing circuit 6 can be increased.

At time t4 that follows, digital processing circuit 6 switches determination timing signal Vtm1 from the low level to the high level. In response to determination timing signal Vtm1, charge amount determination circuit 104 determines whether or not the amount of charges corresponding to voltage Vpls1 at high-potential-side node 120 is equal to or larger than the criterion value. As a result of this determination, when the amount of charges corresponding to voltage Vpls1 is equal to or larger than the criterion value, digital processing circuit 6 performs the write process and completes the series of processes. When the amount of charges corresponding to voltage Vpls1 is smaller than the criterion value, on the other hand, digital processing circuit 6 performs the suspension process without writing updated data in non-volatile memory 7 as described with reference to FIG. 3.

Though an example where current pulses flow in the direction in which rectification circuit 101 is active is described above, semiconductor device SD4 operates similarly also when current pulses flow in a direction in which rectification circuit 201 is active.

Though an example where variable voltage generator 110 switches the output voltage in response to output of boost signal Vup1 by digital processing circuit 6 is described above, a circuit other than digital processing circuit 6 may output boost signal Vup1.

### Effect of Fourth Embodiment

How much the amount of charges that can be processed can be increased by increase in output voltage from variable voltage generator 110 will be described below. The description below is similarly applicable to increase in output voltage from variable voltage generator 210 when charges are accumulated in capacitive elements 202 and 209 by activation of rectification circuit 201.

An increment ΔVpls1 of voltage Vpls1 at high-potential-side node 120 is expressed as

$$Δ Vpls 1 = C 109 \times Δ V / ( C 102 + C 109 ) \qquad ( 1 )$$

where ΔV represents an increment of the output voltage from variable voltage generator 110, C102 represents a capacitance of capacitive element 102, and C109 represents a capacitance of capacitive element 109. This increment ΔVpls1 of the voltage at high-potential-side node 120 means increase in charges that can be used for a process by digital processing circuit 6 by ΔVpls1×(C102+C109).

### [Exemplary Configuration of Variable Voltage Generators 110 and 210]

An exemplary configuration of variable voltage generators 110 and 210 in FIG. 19 will be described below. The circuit configuration shown below is merely by way of example, and limitation thereto is not intended. Any circuit configuration to perform the functions described above may be applicable.

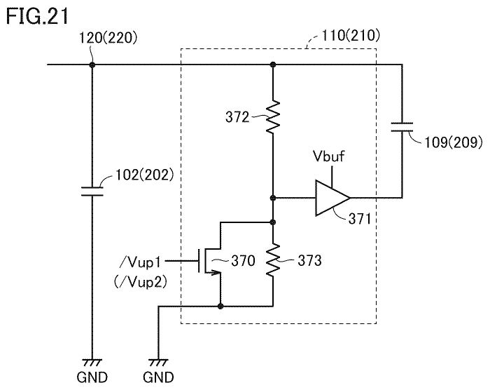

FIG. 21 is a circuit diagram showing an exemplary configuration of variable voltage generator 110 in FIG. 19. FIG. 21 also shows capacitive elements 102 and 109 in FIG. 19. Variable voltage generator 210 is also similar in configuration.

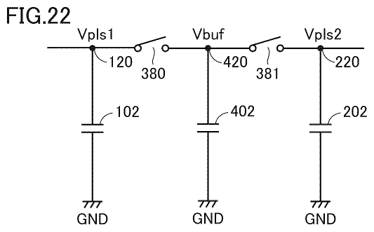

Specifically, variable voltage generator 110 includes an NMOS transistor 370, a voltage buffer 371, and resistive elements 372 and 373. Voltage buffer 371 has an output terminal connected to high-potential-side node 120 of capacitive element 102 with capacitive element 109 being interposed. As will be described later with reference to FIG. 22, a voltage Vbuf different from voltage Vpls1 of capacitive element. 102 is supplied to a power supply terminal of voltage buffer 371. Voltage buffer 371 has an input terminal connected to high-potential-side node 120 with resistive element 372 being interposed and connected to ground GND with resistive element 373 being interposed. Furthermore, NMOS transistor 370 is connected in parallel to resistive element 373. An inverted signal (/Vup1) obtained by inversion of boost signal Vup1 is inputted to a gate terminal of NMOS transistor 370.

FIG. 22 is a diagram for illustrating an exemplary method of supplying voltage Vbuf to the power supply terminal of voltage buffer 371 in FIG. 21. As shown in FIG. 22, a capacitive element 402 is provided separately from capacitive elements 102 and 202 connected to power generation element 1. A switch 380 is connected between high-potential-side node 220 of capacitive element 102 and a high-potential-side node 420 of capacitive element 402, and a switch 381 is connected between high-potential-side node 220 of capacitive element 202 and high-potential-side node 420 of capacitive element 402. Low-potential-side nodes of capacitive elements 102, 202, and 402 are connected to ground GND.

When digital processing circuit 6 performs the series of processes with charges accumulated in capacitive element 102, it turns on corresponding switch 380 for a certain period after the end of the series of processes to move remaining charges that are left in the process to capacitive element 402. Similarly, when digital processing circuit 6 performs the series of processes with charges accumulated in capacitive element 202, it turns on corresponding switch 381 for a certain period after the end of the series of processes to move remaining charges that are left in the process to capacitive element 402. Though there is no charge in capacitive element 402 in an initial state, charges can be held in capacitive element 402 as operations continue. Remaining charges can be reused by using voltage Vbuf generated in capacitive element 402 as a supply voltage for voltage buffer 371.

Capacitive element 402 may be connected to capacitive elements 109 and 209 instead of capacitive elements 102 and 202 with a switch being interposed, or may be connected to both of capacitive elements 102 and 202 and capacitive elements 109 and 209 with a switch being interposed. Similarly, capacitive element 402 for accumulation of remaining charges configured to temporarily be connected to at least one of capacitive elements 102 and 202 and capacitive elements 108 and 208 may be provided also in semiconductor device SD3 in FIG. 17. In this case, boost circuits 107 and 207 in FIG. 17 operate by using the voltage of capacitive element 402 as the supply voltage.

According to the configuration of variable voltage generator 110, when boost signal Vup1 is at the low level, NMOS transistor 370 is set to the on state, so that the input terminal of voltage buffer 371 attains to a ground potential and a low-potential-side node of capacitive element 109 attains to a ground level. In this case, charges generated by power generation element 1 are accumulated in capacitive element 102 and capacitive element 109.

When boost signal Vup1 attains to the high level, NMOS transistor 370 is set to the off state, so that the voltage at the input terminal of voltage buffer 371 increases to a divided voltage resulting from division of the voltage of capacitive element 102 by resistive elements 372 and 373. Consequently, the divided voltage resulting from division of the voltage of capacitive element 102 by resistive elements 372 and 373 is added to the voltage of capacitive element 109 with voltage buffer 371 being interposed.

### Fifth Embodiment

### [Configuration of Batteryless Multi-Turn Encoder]

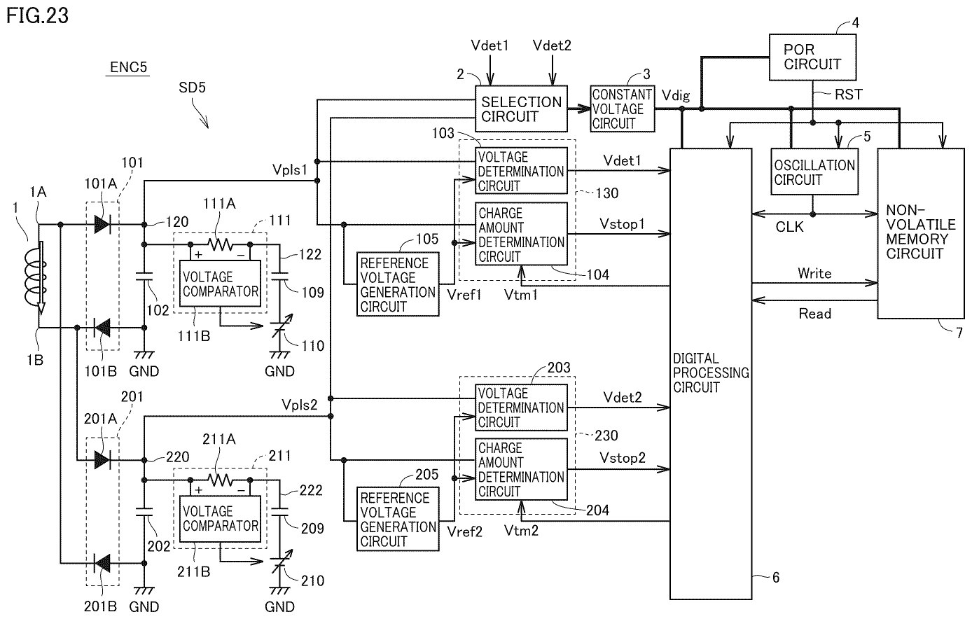

FIG. 23 is a circuit block diagram of a batteryless multi-turn encoder ENC5 according to a fifth embodiment. The fifth embodiment is a modification of the fourth embodiment and characterized in that variable voltage generators 110 and 210 are configured to switch the output voltage after the end of power generation by power generation element 1.

Specifically, a semiconductor device SD5 of batteryless multi-turn encoder ENC5 in FIG. 23 is different from semiconductor device SD1 of batteryless multi-turn encoder ENC1 in FIG. 1 in further including a current determination circuit 111 between high-potential-side node 120 of capacitive element 102 and a high-potential-side node 122 of capacitive element 109 and further including a current determination circuit 211 between high-potential-side node 220 of capacitive element 202 and a high-potential-side node 222 of capacitive element 209.

Current determination circuit 111 determines whether or not there is a current that is flowing between high-potential-side node 120 of capacitive element 102 and high-potential-side node 122 of capacitive element 109. Current determination circuit 111 outputs a control signal to variable voltage generator 110 so as to increase the output voltage from variable voltage generator 110 after this current attains to zero.

By way of example, current determination circuit 111 includes a resistive element 111A and a voltage comparator 111B. Resistive element 111A is connected between high-potential-side node 120 of capacitive element 102 and high-potential-side node 122 of capacitive element 109. Voltage comparator 111B determines whether or not a voltage generated at resistive element 111A is zero by comparing a voltage generated across opposing ends of resistive element 111A. The configuration of current determination circuit 111 is not limited as such.

Similarly, current determination circuit 211 determines whether or not there is a current that is flowing between high-potential-side node 220 of capacitive element 202 and high-potential-side node 222 of capacitive element 209. Current determination circuit 211 outputs a control signal to variable voltage generator 210 so as to increase the output voltage from variable voltage generator 210 after this current attains to zero.

By way of example, current determination circuit 211 includes a resistive element 211A and a voltage comparator 211B. Resistive element 211A is connected between high-potential-side node 220 of capacitive element 202 and high-potential-side node 222 of capacitive element 209. Voltage comparator 211B determines whether or not a voltage generated at resistive element 211A is zero by comparing a voltage generated across opposing ends of resistive element 211A. The configuration of current determination circuit 211 is not limited as such.

Since FIG. 23 is otherwise similar in configuration to FIG. 1, the same or corresponding elements have the same reference characters allotted and description thereof will not be repeated. Capacitive elements 109 and 209, variable voltage generators 110 and 210, and current determination circuits 111 and 211 in FIG. 23 can also be combined with semiconductor device SD2 of batteryless multi-turn encoder ENC2 in the second embodiment shown in FIG. 11.

### [Operation of Batteryless Multi-Turn Encoder]

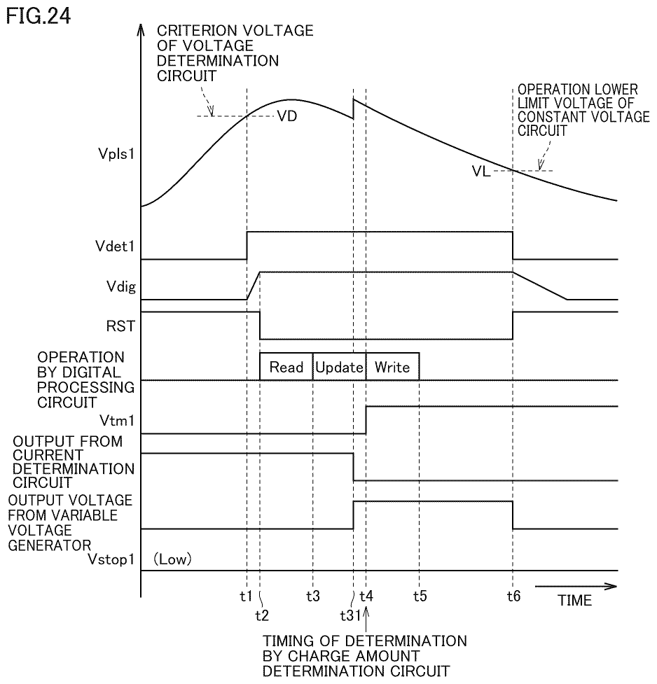

FIG. 24 is a timing chart showing an exemplary ordinary process in batteryless multi-turn encoder ENC5 in FIG. 23.

Though the timing chart in FIG. 24 corresponds to the timing chart in FIG. 20 in the fourth embodiment, it is different from the timing chart in FIG. 20 in that an output signal representing a result of determination by current determination circuit 111 is used instead of boost signal Vup1 outputted from digital processing circuit 6. Since FIG. 24 is otherwise similar to FIG. 20, the same or corresponding elements have the same reference characters allotted and description thereof will not be repeated.

When variable voltage generators 110 and 210 boost a voltage during power generation by power generation element 1, a voltage applied to power generation element 1 increases and hence power generation is interfered by the current in the reverse direction. In order to prevent this, in the fifth embodiment, variable voltage generators 110 and 210 boost the voltage after power generation by power generation element 1 ends. Specifically, current determination circuit 111 determines end of power generation by power generation element 1 by detecting that the current that flows from high-potential-side node 120 of capacitive element 102 toward high-potential-side node 122 of capacitive element 109 attains to zero.

In an example in FIG. 24, current determination circuit 111 outputs a signal at the high level while it detects the current that flows in a direction from high-potential-side node 120 of capacitive element 102 toward high-potential-side node 122 of capacitive element 109. Current determination circuit 111 outputs a signal at the low level when the current attains to zero. Variable voltage generator 110 increases the output voltage at time t31 when output from current determination circuit 111 switches from the high level to the low level.

### Effect of Fifth Embodiment

As set forth above, according to batteryless multi-turn encoder ENC5 in the fifth embodiment, output voltages from variable voltage generators 110 and 210 increase after the end of power generation by power generation element 1. Therefore, increase in current in the reverse direction in power generation element 1 caused by increase in voltage at high-potential-side nodes 120 and 220 is suppressed, and an amount of effective charges that can be used for the process in digital processing circuit 6 can be increased as in the fourth embodiment.

It should be understood that the embodiments disclosed herein are illustrative and non-restrictive in every respect. The scope of this application is defined by the terms of the claims rather than the description above and is intended to include any modifications within the scope and meaning equivalent to the terms of the claims.

### REFERENCE SIGNS LIST

1 power generation element; 2 selection circuit; 3 constant voltage circuit; 4 POR circuit; 5 oscillation circuit; 6 digital processing circuit; 7 non-volatile memory circuit; 101, 201 rectification circuit; 102, 108, 109, 202, 208, 209 capacitive element; 103, 203 voltage determination circuit; 104, 204 charge amount determination circuit; 105, 205 reference voltage generation circuit; 106, 206 peak determination circuit; 107, 207 boost circuit; 110, 210 variable voltage generator; 111, 211 current determination circuit; 120, 122, 220, 222 high-potential-side node; 130, 230 determination circuit; ENC1 to ENC5 batteryless multi-turn encoder; GND ground; RST reset signal; SD1 to SD5 semiconductor device.

1. A semiconductor device that operates with a current pulse generated by a power generation element, the semiconductor device comprising:
a processing circuit to perform a series of processes with the current pulse; and
a determination circuit to determine whether an amount of power generation by the power generation element is sufficient, wherein
the determination circuit determines whether a first determination condition is satisfied before start of the series of processes and during generation of the current pulse by the power generation element and determines whether a second determination condition is satisfied while the series of processes is being performed, and
the processing circuit starts the series of processes when the first determination condition is satisfied and suspends the series of processes when the second determination condition is not satisfied.

2. The semiconductor device according to claim 1, further comprising a first capacitive element in which the current pulse is accumulated, wherein
the processing circuit performs the series of processes with a voltage at a high-potential-side node of the first capacitive element.

3. The semiconductor device according to claim 1, further comprising:
a first capacitive element;
a second capacitive element in which the current pulse is accumulated; and
a boost circuit to boost a voltage of the second capacitive element and to output the boosted voltage to the first capacitive element, wherein
the processing circuit performs the series of processes with a voltage at a high-potential-side node of the first capacitive element.

4. The semiconductor device according to claim 3, further comprising a third capacitive element, wherein
the third capacitive element is configured to temporarily be connected to at least one capacitive element of the first capacitive element and the second capacitive element after the series of processes ends, and remaining charges in the at least one capacitive element move to the third capacitive element, and
the boost circuit operates by using a voltage of the third capacitive element as a supply voltage.

5. The semiconductor device according to claim 1, further comprising:
a first capacitive element and a second capacitive element in which the current pulse is accumulated; and
a variable voltage generator connected between a low-potential-side node of the first capacitive element and a ground, wherein
an output voltage from the variable voltage generator increases after determination as to the first determination condition and before determination as to the second determination condition, and
the processing circuit performs the series of processes with a voltage at a high-potential-side node of the first capacitive element.

6. The semiconductor device according to claim 5, further comprising a current determination circuit to determine whether there is a current that is flowing between the high-potential-side node of the first capacitive element and a high-potential-side node of the second capacitive element, wherein
an output voltage from the variable voltage generator increases when the current determination circuit determines that the current that is flowing between the high-potential-side node of the first capacitive element and the high-potential-side node of the second capacitive element has attained to zero.

7. The semiconductor device according to claim 5, further comprising a third capacitive element, wherein
the third capacitive element is configured to temporarily be connected to at least one capacitive element of the first capacitive element and the second capacitive element after the series of processes ends, and remaining charges in the at least one capacitive element move to the third capacitive element, and
the variable voltage generator operates by using a voltage of the third capacitive element as a supply voltage.

8. The semiconductor device according to claim 2, further comprising a constant voltage circuit to generate a constant supply voltage from the voltage at the high-potential-side node of the first capacitive element when the first determination condition is satisfied, wherein
the processing circuit operates with the constant supply voltage.

9. The semiconductor device according to claim 2, wherein
the first determination condition comprises a condition that the voltage at the high-potential-side node of the first capacitive element is equal to or larger than a first criterion value.

10. The semiconductor device according to claim 9, wherein
the second determination condition comprises a condition that an amount of charges stored in the first capacitive element is equal to or larger than a second criterion value.

11. The semiconductor device according to claim 9, wherein
the second determination condition comprises a condition that a peak value of the voltage at the high-potential-side node of the first capacitive element is equal to or larger than a second criterion value.

12. The semiconductor device according to claim 9, wherein
the second determination condition comprises a condition that the voltage at the high-potential-side node of the first capacitive element at least temporarily exceeds a second criterion value.

13. The semiconductor device according to claim 10, wherein
the series of processes comprises a first process and a second process to be performed after completion of the first process,
the first criterion value is based on an amount of power generation necessary for completion of the first process,
the second criterion value is based on an amount of power generation necessary for completion of the second process, and
the processing circuit does not perform the second process when the second determination condition is not satisfied after completion of the first process.

14. The semiconductor device according to claim 13, further comprising a non-volatile memory, wherein
the first process comprises processing for reading data from the non-volatile memory and processing for updating the read data, and
the second process comprises processing for writing updated data in the non-volatile memory.

15. The semiconductor device according to claim 14, wherein
the processing circuit writes error information into the non-volatile memory when the second determination condition is not satisfied after completion of the first process.

16. The semiconductor device according to claim 14, wherein
a bit for error detection is included at each of beginning and end of the updated data written in the non-volatile memory.

17. A batteryless multi-turn encoder comprising:
a plurality of power generation elements as the power generation element, the plurality of power generation elements being arranged around a rotation shaft with phase angles being shifted; and
the semiconductor device according to claim 1 that operates with current pulses generated by each of the plurality of power generation elements, wherein
each of the plurality of power generation elements comprises a coil to generate electric power by utilizing electromagnetic induction.

18. The batteryless multi-turn encoder according to claim 17, wherein
the series of processes comprises processing for counting the number of generated current pulses, and
the processing circuit corrects a count of the current pulses when the series of processes is suspended.
